(19) United States
(12) Patent Application Publication
(10) Pub. No.: US 2024/0188547 A1
(43) Pub. Date: Jun. 13, 2024

(54) HIVE STRUCTURE WITH FEATURE FACILITATING PROPOLIS ACCUMULATION

(71) Applicant: Jeff JOHNSON, Sioux Falls, SD (US)

(72) Inventor: Jeff JOHNSON, Sioux Falls, SD (US)

(21) Appl. No.: 18/214,666

(22) Filed: Jun. 27, 2023

Related U.S. Application Data
(63) Continuation-in-part of application No. 18/064,365, filed on Dec. 12, 2022.

(51) Int. Cl. A01K 47/02

(52) U.S. Cl. CPC A01K 47/02

(57) ABSTRACT

A hive supporting apparatus for supporting elements of a hive may include a housing assembly having an interior space for accommodating at least one comb and having a housing segment with a perimeter wall having an interior surface about a portion of the interior space. The perimeter wall may include a plurality of wall portions each having a wall portion surface forming a portion of the interior surface and having a primary plane. A section of the interior surface of the perimeter wall may have a propolis-encouraging feature located on at least one of the wall portions of the perimeter wall. The propolis-supporting surface section may have a contour which extends out of the primary plane of the wall portion surface of the respective wall portion.

### REFERENCE TO RELATED APPLICATIONS

This application is a continuation in part of U.S. Non-provisional patent application Ser. No. 18/064,365, filed Dec. 12, 2022, which is hereby incorporated by reference in its entirety.

### BACKGROUND

### Field

The present disclosure relates to beehive structures and more particularly pertains to a new hive structure with a feature to facilitate propolis accumulation to provide the benefits of propolis to a hive in an artificial hive structure.

### SUMMARY

In one aspect, the present disclosure relates to a hive supporting apparatus for supporting elements of a hive. The apparatus may comprise a housing assembly having an interior space for accommodating at least one comb. The housing assembly may include at least one housing segment configured to define a portion of the interior space of the housing assembly, and the housing segment may comprise a perimeter wall having an interior surface for extending about a portion of the interior space circumscribed by the perimeter wall. The perimeter wall may include a plurality of wall portions with each of the wall portions having a wall portion surface forming a portion of the interior surface of the perimeter wall. Each wall portion surface may have a primary plane. A section of the interior surface of the perimeter wall may have a propolis-encouraging feature, and the propolis-encouraging feature may be located on at least one of the wall portions of the perimeter wall. The propolis-supporting surface section may have a contour, and the contour may extend out of the primary plane of the wall portion surface of the respective wall portion.

In another aspect, the present disclosure relates to a method of forming a propolis-encouraging surface on a portion of a hive supporting apparatus. The method may comprise providing a hive element for forming the portion of the hive supporting apparatus, with the hive element having a surface forming a portion of an interior surface of the hive supporting structure and the hive element having a grain direction. The method may also comprise providing an abrading machine having abrading elements, with the abrading machine being configured to move the abrading elements in an abrading direction. The method may further comprise orienting the hive element on the abrading machine such that the grain direction of the element is oblique with respect to the abrading direction, and abrading the surface of the hive element by operating the abrading machine to move the abrading elements in the abrading direction oblique to the grain direction of the hive element to produce contouring of the surface.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic side view of elements of a new hive structure with a feature to facilitate propolis accumulation according to the present disclosure, including a hive supporting apparatus with a housing assembly comprising a plurality of stacked housing segments.

FIG. 2 is a schematic perspective view of an illustrative housing segment of the housing assembly, according to an illustrative embodiment.

FIG. 3 is a schematic top view of the illustrative housing segment of the housing assembly, according to an illustrative embodiment.

FIG. 4 is a schematic side view of a supportive perimeter frame of the hive supporting apparatus, according to an illustrative embodiment.

FIG. 5 is a schematic side view of a section of the interior surface of the perimeter wall of a housing segment with an example of illustrative contours of a propolis-encouraging feature, according to an illustrative embodiment.

FIG. 6 is a schematic side view of a section of the interior surface of the perimeter wall of a housing segment with a further example of illustrative contours of a propolis-encouraging feature, according to an illustrative embodiment.

FIG. 7 is a schematic cross-sectional view of a broken away section of a wall portion of the perimeter wall showing illustrative contours in cross-section, according to an illustrative embodiment.

FIG. 8 is a schematic side view of the abrading elements contacting a portion of the surface of the material, according to an illustrative implementation.

FIG. 9 is a schematic top view of the surface of the material illustrating the grain direction of the material and the abrading direction of the movement of the abrading elements across the surface.

FIG. 10 is a schematic flow diagram of an illustrative method of the disclosure.

### DETAILED DESCRIPTION

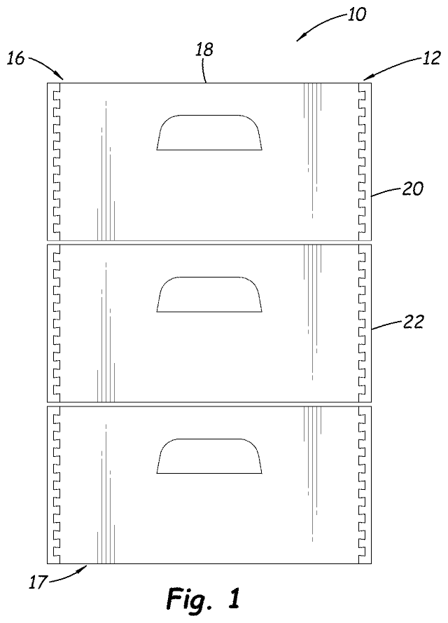

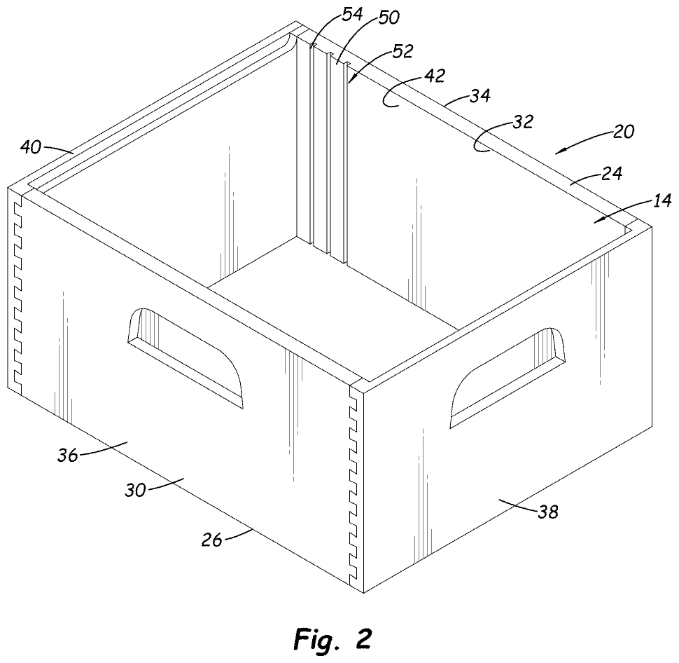

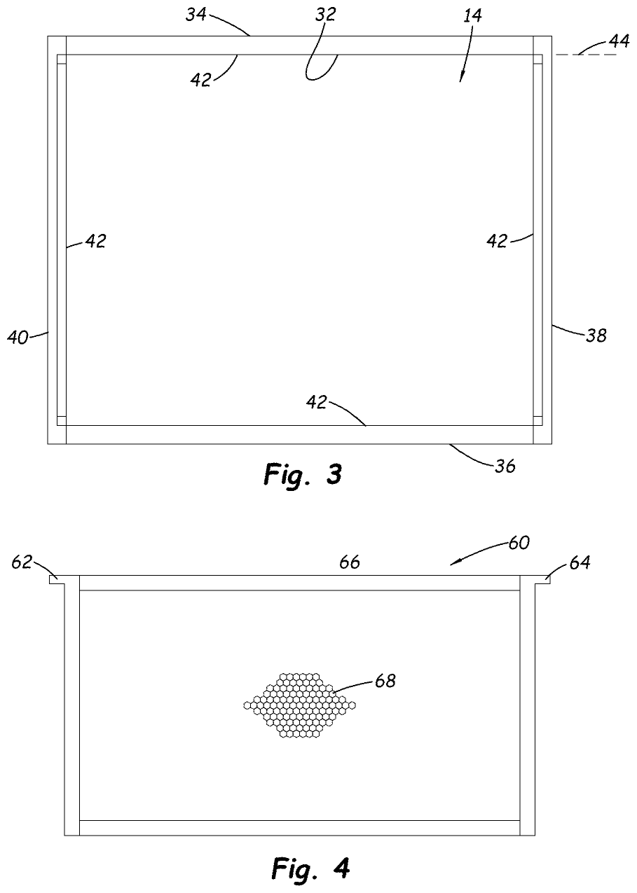

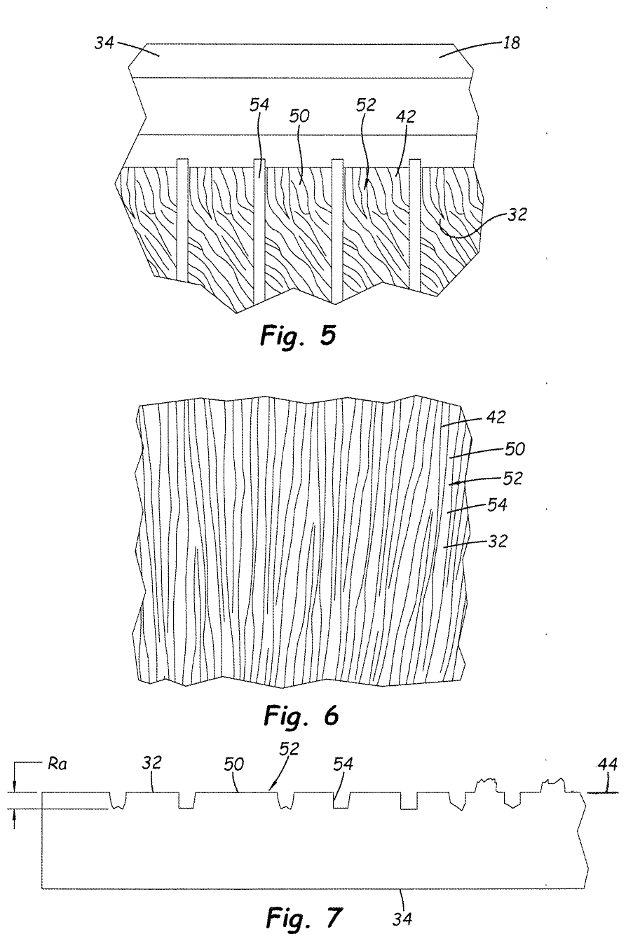

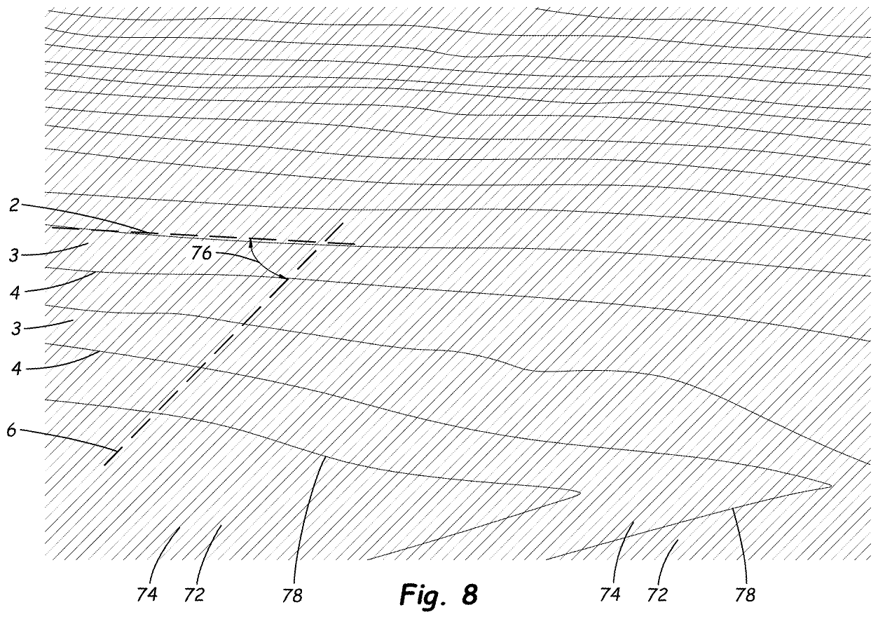

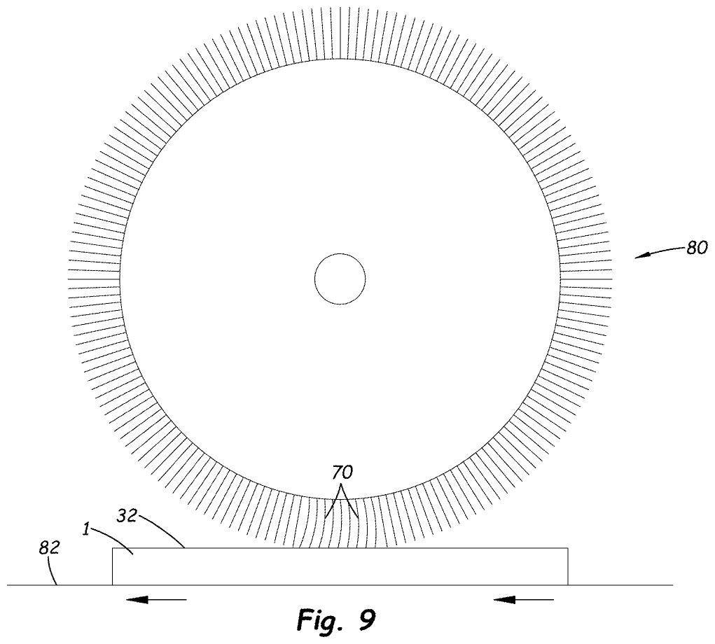

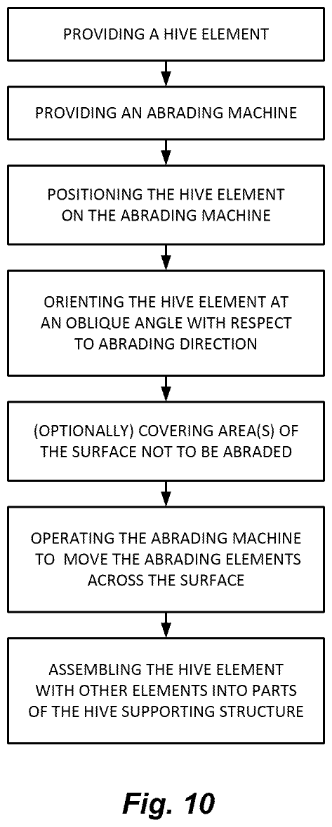

With reference now to the drawings, and in particular to FIGS. 1 through 10 thereof, a new hive structure with at least one feature to facilitate propolis accumulation that embodies the principles and concepts of the disclosed subject matter will be described.

The applicants have recognized that conventional hive boxes are typically optimized for easier cleaning of the boxes, including the inward facing surfaces surrounding the interior of the hive structure that are most likely to come in contact with the bees and the substances brought into the interior of the hive by the bees. To this purpose, the surfaces of the boxes are typically planed and/or sanded smooth to facilitate cleaning of the surfaces as well to simplify the fabrication of the elements forming the hive boxes, usually wood boards. In some cases, the board surfaces may be coated with paint to seal the boards as well as ease the cleaning of the surfaces.

The applicants have also recognized that the smooth finished character of the interior surfaces of the hive box tends to discourage, or at least does not encourage, the deposit of propolis on the interior surfaces of the hive box by the resident bees. Propolis is a resinous substance that the bees of the hive produce by mixing saliva and beeswax with exudate gathered from available plant sources. The function of propolis is believed to be tied primarily to forming the structure of the hive (such as for sealing small cracks in the hive enclosure) in natural locations (e.g., a void in a tree trunk), a function which is generally thought to have less usefulness in man-made or manufactured hive structures which do not have small cracks needing to be closed off. In fact, the accumulation of propolis on the interior surfaces of the manufactured hive boxes has been considered to be a bit of a nuisance, and something to be cleaned or cleared from the hive box.

The applicants have also recognized that research has indicated that propolis may have benefits to the health of the hive and the resident bees, with respect to, for example, warding off parasites and/or disease. Thus, the applicants have recognized that, rather than only being a nuisance in manufactured hive structures, the presence of the propolis may be something to encourage and facilitate the accumulation of in a manufactured hive structure.

The applicants have therefore developed hive structures, and illustratively hive boxes, which include hive elements 1 with features that are believed to encourage and facilitate the accumulation of propolis in the manufactured hive structure by, for example, providing surfaces forming the interior of the hive structure that are contoured in a manner that deviates from a flat and smooth shape to shapes that provide purchase for propolis deposits on the surface. The structures and techniques developed by the applicants are suitable for application to a variety of materials forming the hive boxes and the surfaces of the hive boxes, and the disclosure describes the application to a highly suitable material example, a wood material typically derived from trees.

In some aspects, the disclosure relates to a hive element 1 or elements which are utilized on a hive supporting apparatus 10 which is generally configured to support elements of a hive of bees, in particular honeybees which construct a comb, or honeycomb, to contain honey as well as other elements to support the continuing operation by the bees of the hive. The hive element 1 may have at least one surface with propolis-encouraging features such as contouring.

The hive supporting apparatus 10 includes a housing assembly 12 which has an interior space 14 for accommodating at least one honeycomb. In embodiments of the housing assembly 12, the interior space 14 may be expandable, such as by the housing assembly being modular in construction to permit an extension of the assembly 12 to increase a distance between the top 16 and the bottom 17 of the assembly 12. Additionally, the modularity of the assembly 12 may permit the interior space 14 of the housing assembly to be decreased housing assembly may include a top opening 18 located at the top 16 of the assembly.

The housing assembly 12 may include at least one housing segment 20 which is configured to define a portion of the interior space of the assembly 12. Typically, but not critically, a plurality of the housing segments 20, 22 may be removably stackable upon each other to increase the interior space of the assembly 12. The housing segments 20, 22 may be configured to align with each other when stacked such that the portions of the interior space defined by each of the segments 20, 22 are in communication with each other, and typically vertically aligned with each other. Each of the housing segments 20, 22 has an upper opening 24 and a lower opening 26, and when stacked, the lower opening of an upper housing segment is in communication with the upper opening of a lower housing segment in the stack of segments forming the housing assembly.

In greater detail, each of the housing segments may comprise a perimeter wall 30 with an interior surface 32 which extends about the portion of the interior space 14 circumscribed by the perimeter wall. The perimeter wall 30 may be rectangular in shape in a horizontal cross-section, and may include a plurality of wall portions 34, 36, 38, 40 with each of the wall portions forming one of the sides of the rectangular cross-section. Illustratively, a wall portion may form one of the hive elements 1, and two or more of the wall portions may form two or more of the hive elements. Each of the wall portions 34, 36, 38, 40 has a wall portion surface 42 forming a portion of the interior surface 32 of the perimeter wall. A wall portion surface 42 may define a primary plane 44, and a majority of the wall portion surface may lie in the primary plane. The wall portion surface 42 of adjacent wall portions may be oriented substantially perpendicular to each other.

A section 50 of the interior surface 32 of the perimeter wall has a propolis-encouraging feature 52. The propolis-encouraging feature 52 may be located on at least one of the wall portions 34, 36, 38, 40 of the perimeter wall, and may be located on two or more or all of the wall portions. The propolis-encouraging feature of the section 50 may comprise a propolis-supporting surface. The propolis-supporting surface section 50 may have at least one contour 54. The contour 54 may extend out of the primary plane 44 of the wall portion surface 42 of the respective wall portion. Illustratively, the contour 54 may extend into the wall portion with respect to the primary plane and/or the contour may extend out from the wall portion with respect to the primary plane.

In embodiments, the propolis-supporting surface section 50 may occupy at least approximately 25% of the area of the interior surface 32 of the perimeter wall of a housing segment. In embodiments, the propolis-supporting surface section 50 may occupy less than approximately 75% of the area of the interior surface of the perimeter wall. In embodiments, the propolis-supporting surface section 50 may occupy substantially an entirety of the area of the interior surface of the perimeter wall. In embodiments, the propolis-supporting surface section 50 may occupy between approximately 25% and approximately 75% of the area of the interior surface of the perimeter wall. In some embodiments, the propolis-supporting surface section 50 may occupy less than approximately 25% of the area of the interior surface of the perimeter wall. In other terms, the propolis-supporting surface section 50 may be located on the wall portion surface 42 of one of the wall portions of the housing segment, or optionally two of the wall portions of the housing segment, or optionally three or four of the wall portions of the housing segment.

The contour or contours 54 may be formed on the section 50 of the interior surface in a variety of manners with various degrees of suitability. For example, the contour 54 may be formed on the section 50 of the interior surface 32 by removing material from the interior surface of the wall portion, such as by removing wood material from a board forming the wall portion. Alternatively, or additionally, the contour or contours 54 may be formed on the section 50 of the interior surface 32 by pressing the contours into the interior surface of the wall portion, such as by partially collapsing or crushing areas of the wood material of a board forming the wall portion. Alternatively, or additionally, the contour or contours 54 may be formed by adding material to the interior surface of the wall portion, such as by applying a material to a board forming the wall portion interior surface of the wall portion. In implementations, the formation of the contour or contours 54 may be performed prior to assembly of the wall portions into the fully formed perimeter wall of the housing segment.

As an example of material removal to form the contour or contours, the section 50 of the interior surface 32 may be cut or routed to remove material from the surface of the element (e.g., board) forming the wall portion. As a further example, the contour or contours 54 may be formed by abrading the wall portion surface of the interior surface to remove relatively softer wood material and permit relatively harder wood material to remain. As another example, the contour or contours 54 may be formed by impressing (or pressing contact) of a tool on the wall portion surface 42 of the interior surface. As yet another example, the contour or contours 54 may be formed by embossing the interior surface 32 of the perimeter wall, such as by adding material to the interior surface of the element forming the wall portion.

In some embodiments, the contour or contours 54 may be elongated in shape, and the elongated contours may extend along the section 50 of the interior surface 32 in a primary direction. In some embodiments, the primary direction of the contours 54 may be substantially horizontal and may extend substantially parallel to one (or both) of the upper 24 and lower 26 openings of the housing segment. In some embodiments, the primary direction may be substantially vertical and may extend substantially perpendicular to one (or both) of the upper 24 and lower 26 openings of the housing segment. In still other embodiments, the primary direction may be oblique to the vertical and the horizontal. In embodiments, the contours 54 may extend substantially parallel to each other.

Examples of a feature forming the contour or contours 54 include a slot with substantially parallel side faces and a base face oriented substantially perpendicular to the side faces, a groove with converging side faces, and striations with surfaces that vary in character. The section 50 of the interior surface may include a single one of these features, or may include a plurality of these features which may be spaced from each other with areas of the interior surface which do not have these features. The contours 54 may include one type of these features, or a combination of two or more types of these features.

In some embodiments, the contour 54 of the section of the interior surface may be characterized by a roughness of the interior surface which produces localized deviations of the surface from the primary plane 44. The relative roughness of the section 50 of the interior surface may be further characterized by the profile roughness parameter (Ra). In some embodiments, Ra may be greater than approximately 1/64th inch (e.g., approximately 0.016 inch, or approximately 0.4 mm). In embodiments, Ra may be less than approximately ¼ inch (e.g., approximately 0.25 inch or approximately 6.4 mm), and Ra may be less than approximately ⅛ inch (e.g., approximately 0.125 inch or approximately 3.2 mm).

In some embodiments of the disclosure, the housing assembly 12 of the hive structure may include at least one supportive perimeter frame 60 for supporting a comb of the hive, and the perimeter frame or frames may be removably mounted on the housing segment 20. The supportive perimeter frame 60 may have a pair of support tabs 62, 64 extending from opposite ends of the frame 60, and the support tabs may engage opposite wall portions of the perimeter wall 30, such as by resting in recesses formed in the top edges of the respective wall portions. The supportive perimeter frame or frames 60 typically define an opening 66, and a comb supportive member 68 may extend across the opening 66 to provide a base for combs constructed by the bees resident in the hive. Often, the housing assembly 12 may also comprise a top cover positioned at the top 16 of the housing assembly to cover the top opening 18 of the assembly 12 situated on the uppermost housing segment. The housing assembly 12 may also comprise a bottom wall positioned at the bottom 17 of the housing assembly 12 and may be positioned in a lower opening of the lowermost housing segment.

In an illustrative implementation of the disclosure, abrading of the interior surface 32 causes abrasive removal of material from the surface 32 and produces a contoured section 50 of the surface to be formed. In the implementation, the contouring is created by a combination of the natural characteristics of the wood material and aspects of the abrading operation utilized.

The hive element 1 which has the section 50 of the surface 32 providing the propolis-encouraging feature 52 may have a grain, such as is characteristic of a wood material in a natural form (e.g., not ground into small pieces and reformed using a bonding agent). Typically, the grain of the element 1 has a grain direction 2 which generally corresponds to the direction of the grain across the wood material, and particularly the surface of the wood material. When the housing segment 20 is oriented for use, the grain direction is typically oriented substantially horizontally although other orientations may be utilized. The grain of the wood material may be formed by growth rings of the tree or plant from which the wood material was obtained. The growth rings may include areas of material with relatively higher density or hardness and areas of material with relatively lower density or hardness, such as may result from growth during different times of the year or growing season. The areas of relatively lower density material may form bands 3 of lower density material and the areas of higher density material may form bands 4 of higher density material. Illustratively, the wood material may be a pine wood, such as a white pine wood. The wood comprising an eastern white pine wood.

In the illustrative technique, the abrading of the surface 32 of the hive element is performed along a plurality of lines of abrasion, and the plurality of lines may have an abrading direction 6 with the lines being substantially straight and being oriented substantially parallel to each other. The abrading of the surface of the element 1 may be accomplished by moving abrading elements 70 across the interior surface 32. Illustratively, the abrading elements 70 may comprise bristles or tines of a suitably stiff character with the ends of the bristles being brought into contact with the surface 32 and being moved across the surface to produce a movement of the ends that is substantially parallel to the abrading direction along the plurality of lines. The movement of the ends of the bristles across the surface 32 may produce a plurality of grooves 72 formed into the interior surface 32 with a ridge 74 being formed between adjacent grooves, with the grooves and ridges being substantially parallel.

The abrading of the interior surface 32 may be performed in an orientation transverse to the grain direction of the wood material such that the lines of abrasion cross or traverse the grain of the wood material. Significantly, the abrading of the surface 32 may produce a greater degree of material removal from the bands 3 of lower density material and a lesser degree of material removal from the bands 4 of higher density material, The abrading direction 6 may be oriented at a transverse angle 76 with respect to the grain direction 2. The transverse angle 76 may be oblique in measurement. In some of the broadest aspects of the disclosure, the transverse angle 76 may measure between approximately 20 degrees and approximately 70 degrees, and in some aspects, the transverse angle 76 may measure between approximately 30 degrees and approximately 60 degrees. In an illustrative embodiment, the transverse angle measures approximately 45 degrees. Although not as preferred as other configurations, the transverse angle may measure approximately 90 degrees.

The intersection of the bands 3 of lower density material and bands 4 of higher density material with the grooves 72 and ridges 74 formed by abrasion of the abrading elements produces irregularity in the physical character of the ridges 74 and grooves 72, such as variations in the height of the ridges and variations in the depth of the grooves. The variations in protrusion of the ridges and the depth of the grooves may produce a plurality of bump contours 78 at or about the locations of the intersections of the ridges 74 and the bands 4 of hired in the material. The bump contours 78 may be perceptible to a person's fingertip moving along one of the ridges and also may be perceptible to a person's fingertip moving along one of the bands of higher density material of the wood grain.

Advantageously, it has been observed that even if the grooves 72 and ridges 74 are substantially evenly spaced with respect to each other, the randomness of the widths of the bands of lower density material and bands of higher density material that typically naturally occurs in the wood grain produces a randomness of sizes of the bump contours and a randomness of intervals between adjacent bump contours.

Illustratively, one highly suitable apparatus for performing the abrading of the material on the interior surface 32 is the SUPERBRUSH DOUBLE BRUSH SANDER available from SuperMax Tools of 5250 W. 74^{th} St., Suite #12, 5250 W. 74^{th} St. Edina, Minnesota. The Brush Sander maybe fitted with a wire brush having a medium stiffness, and may rotate at a speed of approximately 900 RPM to approximately 1200 RPM, and the material may be moved with respect to the brush at a relative feed rate (e.g., material supporting belt) setting of approximately 25 to approximately 35. Significantly, conventional use of the Brush Sander machine has the material being moved in a direction that is substantially parallel to the direction of the grain, so that the bristles of the brush contacting the material move parallel to the direction of the grain of the material. Insofar as is known, movement of the material in a manner such that the brush bristles do not move in a direction parallel to the grain of the material has not conventionally been utilized.

In another aspect, the disclosure relates to a method of forming a propolis-encouraging or facilitating surface on a portion of a hive supporting apparatus 10. The surface may be an interior surface of the hive supporting apparatus, such as the interior surface 32 of the housing segment. The method may include providing a hive element 1 for forming the portion of the hive supporting apparatus having a surface suitable for forming an interior surface of the apparatus 10. Illustratively, the hive element comprises one portion of the perimeter wall 30 of the housing segment, although other elements of the hive supporting apparatus 10 may form the height element.

The method may also include providing an abrading machine 80 having abrading elements 70 and a bed 82 for supporting a workpiece to be abraded by movement of the abrading elements. Illustratively, the abrading elements may be mounted on and extend from a rotating drum of the abrading machine. The abrading machine 80 may be configured to move the abrading elements 70 in the abrading direction 6, and may also be configured to transport or move the bed 82 of the abrading machine in a transport direction. The transport direction may be oriented parallel to the abrading direction such that the abrading elements move parallel to the bed, as well as objects supported on the bed, such as the hive element 1.

The method may further include positioning the hive element on the bed 82 of the abrading machine with the surface 32 being oriented toward the abrading elements 70 to be contacted by the abrading elements. Significantly, the positioning of the hive element 1 on the bed 82 may include orienting the hive element on the bed such that the grain direction 2 of the element is oblique with respect to the abrading direction 6, and may include orienting the hive element on the bed such that the grain direction 2 of the element is oblique with respect to the transport direction of the bed.

Optionally, the method may include the step of covering areas of the surface of the hive element to block abrasion of those areas of the surface by the abrading elements, while other areas of the surface not covered are abraded. Illustratively, when the hive element is a wall portion of the perimeter wall of the housing segment, covered areas of the surface may be located toward ends of the wall portion to avoid abrasion of areas designed to be joined together or forming a joint.

The method may further include operating the abrading machine to move the bed of machine in the transport direction, as well as the hive element supported on the bed, and to abrade the surface of the hive element to produce contouring of the surface by movement of the the abrading elements in the abrading direction across the surface. Subsequently, the method may include, if the hive element comprises a wall portion of the perimeter wall, assembling the wall portion with other wall portions into the perimeter wall of the housing segment, and assembling one or more housing segments into the housing assembly of the hive supporting apparatus.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

We claim:

1. A hive supporting apparatus for supporting elements of a hive, the apparatus comprising:
a housing assembly having an interior space for accommodating at least one comb, the housing assembly including:
at least one housing segment configured to define a portion of the interior space of the housing assembly, the at least one housing segment comprising a perimeter wall having an interior surface for extending about a portion of the interior space circumscribed by the perimeter wall, the perimeter wall including a plurality of wall portions with each of the wall portions having a wall portion surface forming a portion of the interior surface of the perimeter wall, each wall portion surface having a primary plane;
wherein a section of the interior surface of the perimeter wall has a propolis-encouraging feature, the propolis-encouraging feature being located on at least one of the wall portions of the perimeter wall, the propolis-supporting surface section having a contour, the contour extends out of the primary plane of the wall portion surface of the respective wall portion.

2. The apparatus of claim 1 wherein the contour extends into the wall portion with respect to the primary plane.

3. The apparatus of claim 2 wherein the contour is formed by removing material from the interior surface of the at least one wall portion.

4. The apparatus of claim 2 wherein the contour is formed by pressing contours into the interior surface of the at least one wall portion.

5. The apparatus of claim 1 wherein the contour extends out from the wall portion with respect to the primary plane.

6. The apparatus of claim 5 wherein the contour is formed by adding material to the interior surface of the at least one wall portion.

7. The apparatus of claim 1 wherein the contour comprises at least one slot formed into the interior surface of the at least one wall portion.

8. The apparatus of claim 1 wherein the contour comprises a plurality of slots formed into the interior surface of the at least one wall portion.

9. The apparatus of claim 1 wherein the at least one housing segment has upper and lower openings; and
wherein the contour extends along the portion of the interior surface in a primary direction, the primary direction being substantially horizontal and extending substantially parallel to one of the upper and lower openings of the housing segment.

10. The apparatus of claim 1 wherein the at least one housing segment has upper and lower openings; and
wherein the contour extends along the portion of the interior surface in a primary direction, the primary direction being substantially vertical and extending substantially perpendicular to one of the upper and lower openings.

11. The apparatus of claim 1 wherein the at least one housing segment has upper and lower openings; and
wherein the contour extends along the portion of the interior surface in a primary direction, the primary direction being oblique to one of the upper and lower openings.

12. The apparatus of claim 1 wherein the propolis-encouraging feature includes a plurality of contours extending substantially parallel to each other.

13. The apparatus of claim 1 wherein the hive supporting apparatus additionally comprises at least one supportive perimeter frame removably mounted on the at least one housing segment of the housing assembly, a comb supportive member extending across the opening of the at least one supportive perimeter frame.

14. The apparatus of claim 1 wherein the wall portion of the perimeter wall is formed of a wood material with a grain extending in a grain direction on the interior surface, the section of the interior surface having abrasions extending in an abrading direction, the abrading direction being oriented at an oblique angle to the grain direction of the grain.

15. A method of forming a propolis-encouraging surface on a portion of a hive supporting apparatus, the method comprising:
providing a hive element for forming the portion of the hive supporting apparatus, the hive element having a surface forming a portion of an interior surface of the hive supporting structure, the hive element having a grain direction;
providing an abrading machine having abrading elements, the abrading machine being configured to move the abrading elements in an abrading direction;
orienting the hive element on the abrading machine such that the grain direction of the element is oblique with respect to the abrading direction; and
abrading the surface of the hive element by operating the abrading machine to move the abrading elements in the abrading direction oblique to the grain direction of the hive element to produce contouring of the surface.

16. The method of claim 15 additionally comprising covering one or more areas of the surface of the hive element to block abrasion of the areas of the surface by the abrading elements.

17. The method of claim 15 wherein the hive element comprises a portion of a perimeter wall of the housing segment of the housing assembly of the hive supporting apparatus; and
wherein the method additionally comprises:
assembling the perimeter wall with other perimeter wall portions such that the contoured surface forms an interior surface of the perimeter wall of the housing segment;
placing the housing segment with the contoured interior surface into the hive supporting apparatus; and
exposing the contoured surface of the hive supporting apparatus to bees.

18. The method of claim 15 wherein the abrading machine includes a bed, the abrading machine being configured to move the bed in a transport direction, the transport direction being parallel to the abrading direction of the abrading elements such that the abrading elements and the bed move substantially parallel to each other; and
wherein the method additionally comprises:
positioning the hive element on the bed of the abrading machine with the surface oriented to be contacted by the abrading elements;
orienting the hive element on the bed such that the grain direction of the element is oblique with respect to the transport direction of the bed; and
moving the hive element with the bed in the transport direction such that the grain direction is oblique to the transport direction and the abrading direction.
